(19) United States
(12) Patent Application Publication
(10) Pub. No.: US 2026/0054963 A1
(43) Pub. Date: Feb. 26, 2026

(54) LIFT SAFETY SYSTEM AND METHOD FOR TESTING FUNCTIONALITY THEREOF

(71) Applicant: Otis Elevator Company, Farmington, CT (US)

(72) Inventors: Lu Xu, Shanghai (CN); Chong Meng, Shanghai (CN)

(21) Appl. No.: 19/303,991

(22) Filed: Aug. 19, 2025

(30) Foreign Application Priority Data
Aug. 21, 2024 (CN) 202411156531.X

(51) Int. Cl. B66B 5/00; B66B 5/02

(52) U.S. Cl. CPC B66B 5/0093; B66B 5/02

(57) ABSTRACT

An elevator safety system and a method for testing functionality thereof. A method for testing functionality of an elevator braking system. In the method, a first connector is connected in parallel to both ends of a first contact, then a second contact is transitioned to a disconnected state, to determine whether the functionality of a second holding brake is operating normally based on the motion state of a car after the second contact is transitioned to a disconnected state. A second connector is further connected in parallel to both ends of the second contact, then the first contact is transitioned to a disconnected state, to determine whether the functionality of a first holding brake is operating normally based on the motion state of the car after the first contact is transitioned to a disconnected state.

### FOREIGN PRIORITY

This application claims priority to Chinese Patent Application No. 202411156531.X, filed Aug. 21, 2024, and all the benefits accruing therefrom under 35 U.S. C. § 119, the contents of which in its entirety are herein incorporated by reference.

### TECHNICAL FIELD OF INVENTION

The present disclosure relates to an elevator technology, and in particular to an elevator safety system and a method for testing functionality thereof.

### BACKGROUND OF THE INVENTION

An elevator brake or holding brake is a key component of an elevator safety system, for providing the necessary braking force during elevator operation, to ensure that the elevator can be stopped safely when needed. An elevator braking system typically comprises two or more braking components. To ensure reliability of the brake, it is necessary to check whether a single brake component can provide sufficient braking force when needed.

### SUMMARY OF THE INVENTION

According to one aspect of the present disclosure, there is provided a method for testing functionality of an elevator braking system. The tested elevator braking system comprises: a first holding brake and a second holding brake; a first contact connected between the first holding brake and a drive power supply, and a second contact connected between the second holding brake and the drive power supply; and a first connector controllably connected in parallel to both ends of the first contact, and a second connector controllably connected in parallel to both ends of the second contact. In the method described above, the first connector is connected in parallel to both ends of the first contact to bypass the first contact, then the second contact is transitioned from a closed state to a disconnected state, and it is to determine whether the functionality of the second holding brake is operating normally based on a motion state of a car after the second contact is transitioned from a closed state to a disconnected state. The above method may also be used to test the functionality of the first holding brake, comprising the steps of: first connecting the second connector in parallel to both ends of the second contact to bypass the second contact, then transitioning the first contact from a closed state to a disconnected state, and determining whether the functionality of the first holding brake is operating normally based on the motion state of the car after the first contact is transitioned from a closed state to a disconnected state.

Optionally, in the above method, the first contact and the second contact are controlled by an emergency stop switch.

Optionally, in the above method, the first connector and the second connector take the form of plug/socket connectors.

Optionally, in the above method, the motion state comprises at least one of: a distance travelled by the car before it stops moving, and a curve of velocity change over time of the car before it stops moving.

According to another aspect of the present disclosure, there is provided an elevator braking system. The elevator braking system comprises: a first holding brake and a second holding brake; a first contact connected between the first holding brake and a drive power supply, and a second contact connected between the second holding brake and the drive power supply; and a first connector controllably connected in parallel to both ends of the first contact, and a second connector controllably connected in parallel to both ends of the second contact. The elevator braking system as described above includes a first test mode and a second test mode. In the first test mode, the first connector is connected in parallel to both ends of the first contact, and the second contact is transitioned from a closed state to a disconnected state to determine whether the functionality of the second holding brake is operating normally based on a motion state of a car after the second contact is transitioned from a closed state to a disconnected state. In the second test mode, the second connector is connected in parallel to both ends of the second contact, and the first contact is transitioned from a closed state to a disconnected state to determine whether the functionality of the first holding brake is operating normally based on the motion state of the car after the first contact is transitioned from a closed state to a disconnected state.

Optionally, the above elevator braking system further comprises an emergency stop switch interlinked with the first contact and the second contact. Further optionally, the above emergency stop switch is a manual switch.

Optionally, in the above elevator braking system, the first connector and the second connector take the form of plug/socket connectors. Further optionally, the sockets of the plug/socket connectors are fixedly disposed at both ends of the first contact and the second contact, and the sockets are suitable for electrical connection via a cable with plugs provided at the ends. Still further optionally, the first connector and the second connector share the same cable.

### BRIEF DESCRIPTION OF THE DRAWINGS

The above and/or other aspects and advantages of the present disclosure will become clearer and easier to understand in conjunction with the following description in various aspects of the drawings. The same or similar units in the drawings are represented by the same reference numerals. The drawings include:

FIG. 1 shows an exemplary diagram of an elevator system.

FIG. 2 shows a schematic block diagram of an elevator system.

FIG. 3 shows a schematic bock diagram of an elevator braking system according to one embodiment of the present disclosure.

FIG. 4 shows a schematic diagram of the elevator braking system illustrated in FIG. 3.

FIG. 5 shows a schematic diagram of the elevator braking system illustrated in FIG. 3 in a first test mode.

FIG. 6 shows a schematic diagram of the elevator braking system illustrated in FIG. 3 in a second test mode.

FIG. 7 shows a flow diagram of a method for testing functionality of an elevator braking system according to another embodiment of the present disclosure.

### DETAILED DESCRIPTION OF THE INVENTION

The present disclosure will be more fully described hereinafter with reference to the drawings of the exemplary embodiments of the present disclosure. However, the present disclosure may be implemented in different forms, and should not be construed as being limited only by the various embodiments provided herein. The various embodiments aim to make the present disclosure more comprehensive and complete, so that the protection scope of the present disclosure would be more fully conveyed to a person skilled in the art.

In this specification, the terms such as “comprise” and “include” indicate that in addition to the units and steps directly and explicitly stated in the specification and claims, the technical solution of the present disclosure also does not exclude the circumstances where there are other units and steps that are not directly or explicitly stated.

In this specification, the elevator safety functionality generally refers to a variety of elevator safety-related functions, including, but not limited to, emergency brake function (automatically activating an emergency brake system to stop the car in case of emergency), door safety function (for ensuring that the elevator door stays closed during operation), overspeed protection function (for preventing the car motion speed from exceeding the safety speed), overload protection function (for preventing the car from overload operation), emergency alarm and communication function, safety circuit monitoring function (for monitoring the status of multiple safety switches to ensure that all safety-related components are operating normally), holding brake status monitoring function (for monitoring whether the holding brake is in normal operation), leveling control function (for ensuring that the elevator stops precisely at the designated floor) and anti-pinch function (for detecting obstacles that appear when the elevator door is closing), etc.

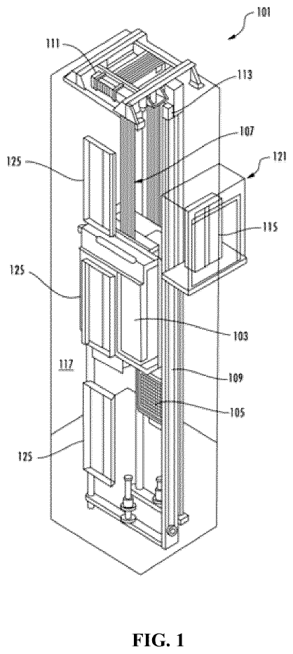

FIG. 1 shows an exemplary diagram of an elevator system. The elevator system 101 illustrated by FIG. 1 includes an elevator car 103, a counterweight 105, tensioning member

The elevator system 101 includes an elevator car 103, a counterweight 105, a tension member 107, a guide rail (or rail system) 109, a unit (or unit system) 111, a position reference system 113 and an electronic elevator controller (controller) 115. The elevator car 103 and the counterweight 105 may be coupled to each other by the tension member 107. The tension member 107 may include or be configured as, for example, a rope, a steel cable and/or a coated steel strip. The counterweight 105 is configured to balance the load of the elevator car 103, and is configured to facilitate moving the elevator car 103 within the elevator shaft (or hoistway) 117 and along the guide rail 109 relative to the counterweight 105 in the opposite direction and simultaneously.

The tension member 107 may be coupled to the unit 111 which may form part of the overhead structure of the elevator system 101. The unit 111 is configured to control movement between the elevator car 103 and the counterweight 105. The position reference system 113 may be installed on a fixed portion at the top of the elevator shaft 117, for example, on a support member or guide rail, and may be configured to provide position signals regarding the position of the elevator car 103 in the elevator shaft 117. In other embodiments, the position reference system 113 may be installed directly on a mobile component of the unit 111, or may be located in other positions and/or configurations known in the art. The position reference system 113 may be any device or mechanism known in the art for monitoring the position of the elevator car and/or the counterweight. As may be understood by a person skilled in the art, the position reference system 113, for example, includes but is not limited to encoders, sensors or other systems, and may perform various sensing such as velocity sensing, absolute position sensing and the like.

As shown therein, the controller 115 is located in a control room 121 of the elevator shaft 117, and is configured to control the operation of the elevator system 101 (and in particular, the elevator car 103). For example, the controller 115 may send drive signals to the unit 111 to control acceleration, deceleration, levelling, stopping etc. of the elevator car 103. The controller 115 may also be configured to receive position signals from the position reference system 113 or any other desirable position reference device. When moving up or down along the guide rail 109 within the elevator shaft 117, the elevator car 103 may stop at one or more landings 125 as controlled by the controller 115. In spite of being illustrated in the control room 121, a person skilled in the art will appreciate that the controller 115 may be located and/or configured in other places or positions within the elevator system 101. In one embodiment, the controller may be remotely located or positioned in the cloud.

The unit 111 may include a motor or a similar driving mechanism. According to the embodiments of the present disclosure, the unit 111 is configured to include an electrically driven motor. The power supply of the motor may be any power source, including a power grid, and the power source in combination with other components are supplied to the motor. The unit 111 may include traction sheaves which impart a force to the tension member 107 so as to move the elevator car 103 within the elevator shaft 117.

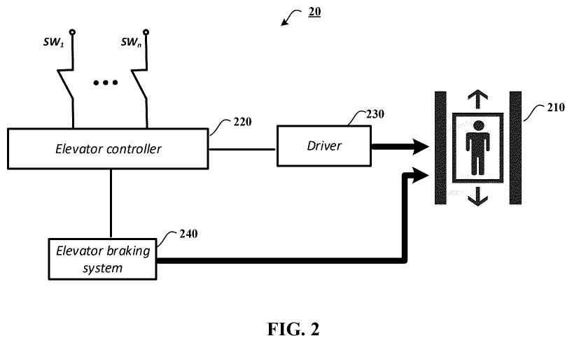

FIG. 2 shows a schematic block diagram of an elevator system. As illustrated in FIG. 2, the elevator system 20 includes a car 210, an elevator controller 220 (e.g., the controller 115 in FIG. 1), a driver 230 (e.g., the unit 111 in FIG. 1), an elevator braking system 240 and a plurality of safety switches SW1 to SWn.

Based on the control commands of the elevator controller 220, the driver 230 controls movement between the car 210 and the counterweight, so that the car 210 can stop at the desired landing. In a normally operating elevator system, under the control of the elevator controller 220, when the car 210 stops at a landing, the holding brake in the elevator braking system 240 locks into place to hold the car 210 stationary at its current position. In the process of the car 210 moving towards a target landing, however, the holding brake is in a released state.

In the elevator system illustrated in FIG. 2, the elevator controller 210 is connected either to the safety switches SW1 to SWn or to a device for detecting the status of the safety switches SW1 to SWn (e.g., sensors for sensing the safety switches). Under common circumstances, in the event of an abnormality such as an unintended disconnection of a landing door switch, the holding brake in the elevator braking system 240 will be de-energized and in an engaged state.

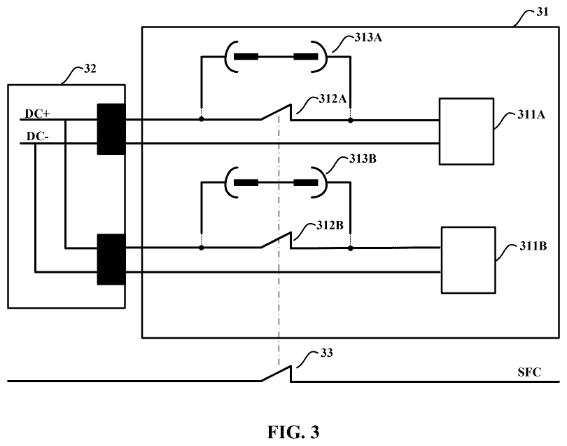

FIG. 3 shows a schematic bock diagram of an elevator braking system according to one embodiment of the present disclosure. It illustrates an exemplary embodiment of the elevator braking system 240 in FIG. 2.

The elevator braking system 31 illustrated in FIG. 3 includes holding brakes 311A and 311B, normally closed contacts 312A and 312B, and connectors 313A and 313B.

The holding brakes 311A and 311B typically include components such as brake arms, brake blocks (friction materials) and brake wheels (or brake discs). The brake arms are connected to an electromagnet or other driving mechanism, while the brake blocks are in contact with the brake wheels. Exemplarily, the electromagnet generates a magnetic force in an energized state, attracting the brake arms and separating the brake blocks from the brake wheels, thus allowing for normal operation of the elevator. When the elevator controller or elevator safety control device detects an emergency or a power failure, the electromagnet is de-energized. The brake arms push the brake blocks to press tightly against the brake wheels under a spring force, generating a friction force that decelerates the elevator and ultimately stops it.

The normally closed contact 312A is connected between the holding brake 311A (e.g., the electromagnet of the holding brake) and a drive power supply 32, while the normally closed contact 312B is connected between the holding brake 311B and the drive power supply 32. The normally closed contacts described herein refer to a type of electrical switch contacts that are in a closed state, i.e. the circuit is connected, in the absence of any operation or without any application of control signals. When the control signals are activated or the switch is operated, the contacts will open, breaking the circuit. As illustrated in FIG. 3, the safety switch 33 (e.g., an emergency stop switch ES) is accessed to a safety circuit SFC, and is configured to interlink with the normally closed contacts 312A and 312B (represented by dashed lines in the figure). When it is disconnected, the normally closed contacts 312A and 312B will transition from a closed state to a disconnected state. It should be noted that for the purpose of simplified description, only one safety switch is illustrated in the safety circuit SFC in FIG. 3. In an actual elevator system, however, the safety circuit will be accessed to multiple safety switches (e.g., sensing limit switches, overspeed switches, upward overspeed switches, pit ladder switches, switches indicating non-operating positions of mechanical devices, slack rope trigger switches for steel strips or steel ropes, speed limiter rope tension indication switches, car door switches, pit stop switches, safety window switches, car top stop devices, buffer switches, host stop devices and emergency stop operation panel switches etc.)

The elevator braking system illustrated in FIG. 3 further includes connectors 313A and 313B. The connector 313A is controllably connected in parallel to both ends of the normally closed contact 312A to bypass the normally closed contact 312A. That is, the holding brake 311A and the drive power supply 32 remain connected regardless of whether the normally closed contact 312A is in a closed or disconnected state. Likewise, the connector 313B is controllably connected in parallel to both ends of the normally closed contact 312B to bypass the normally closed contact 312B. From the description below, it will be appreciated that the connectors 313A and 313B serve to bypass the corresponding normally closed contacts only when the elevator braking system is in a test mode (in FIG. 3, connecting a connector to both ends of a normally closed contact using dashed lines intends to indicate that the parallel connection between the connector and the normally closed contact is optional).

The term “controllably” herein refers to that the connector 313A can be connected in parallel to the normally closed contact 312A or the connector 313B can be connected in parallel to the normally closed contact 312B as needed (e.g., to test the functionality of the holding brake). That is, such parallel connection is not fixed but variable. The controllable parallel connection as described above can be realized in various ways. In some examples, the connectors 313A and 313B take the form of plug/socket connectors for the convenience of connection and removal. The connectors may, for example, include sockets, plugs and cable(s) that connect the plugs with the sockets, wherein the sockets are fixedly disposed at both ends of the normally closed contacts 312A and 312B, and the plugs are disposed at the ends of the cable(s). When it is necessary to bypass a normally closed contact (e.g., contact 312A), the plugs may be put into the sockets disposed at both ends of the corresponding contact so that the sockets are connected via a cable. Optionally, the connectors 313A and 313B may be two separate components; further optionally, the connectors 313A and 313B may share the same cable, i.e., the cable is either used to connect sockets at both ends of the normally closed contact 312A, or to connect sockets at both ends of the normally closed contact 312B. Since the connectors 313A and 313B share the same cable, this can ensure that only one of the normally closed contacts 311A and 312B is bypassed at any given time. In some other examples, the parallel connection between the connectors and the normally closed contacts may be controlled by means of electrical signals. For example, connectors 313A and 313B may be switches whose energized or de-energized state is controlled by electrical signals.

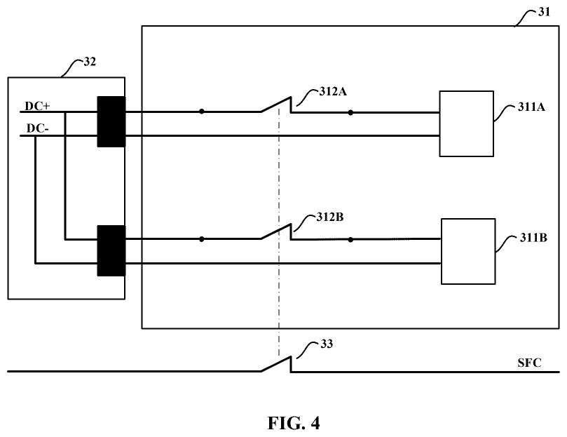

The elevator braking system illustrated in FIG. 3 may operate in a work mode or a test mode. FIG. 4 shows a schematic diagram of the elevator braking system illustrated in FIG. 3 in a work mode. In the work mode, the holding brakes 311A and 311B are connected to the drive power supply 32 via the normally closed contacts 312A and 312B respectively, and the safety switch 33 is interlinked with the contacts 312A and 312B. In the event that the elevator system is in normal operation, when the car is travelling, the electromagnets of the holding brakes 311A and 311B would generate magnetic force under the energized state, thus attracting the brake arms to separate the brake blocks from the brake wheels. When the car intends to stop at a destination floor, the power supply to the electromagnets of the holding brakes 311A and 311B will be cut off, resulting in the brake arms to push the brake blocks to press tightly against the brake wheels, thus decelerating the car by friction and finally stopping it at the destination floor. In addition, in the event of an emergency or a failure, the normally closed contacts 312A and 312B can be transitioned from a closed state to a disconnected state by, for example, manual operation of the safety switch 33. At this moment, since the electromagnets are de-energized, the brake blocks will be pressed tightly against the brake wheels to cause the car to stop moving as soon as possible.

The test mode of the elevator braking system may include a first test mode and a second test mode, for respectively determining whether the functionality of the holding brakes 311A and 311B is operating normally (also known as the single brake functionality test).

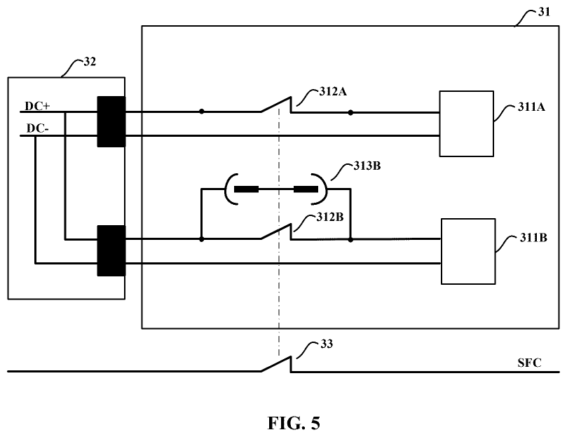

FIG. 5 shows a schematic diagram of the elevator braking system illustrated in FIG. 3 in a first test mode. In the first test mode, the holding brakes 311A and 311B are connected to the drive power supply 32 via the normally closed contacts 312A and 312B respectively, and the safety switch 33 is interlinked with the normally closed contacts 312A and 312B. Further, the connector 313B is connected to both ends of the normally closed contact 312B, while the connector 313A is not connected to both ends of the normally closed contact 312A. During the test, the normally closed contacts 312A and 312B can be transitioned from a closed state to a disconnected state by manual operation of the safety switch 33. At this moment, the electromagnet of the holding brake 311B remains in an energized state due to the bypass effect of the connector 313B, thus separating the brake blocks from the brake wheels. On the other hand, the electromagnet of the holding brake 311A is de-energized as the normally closed contact 312A enters a disconnected state, and thus it is possible to determine whether the functionality of the holding brake 311A is operating normally, e.g. whether it can provide sufficient braking force, based on the motion state of the car after the normally closed contact 312A is transitioned from a closed state to a disconnected state.

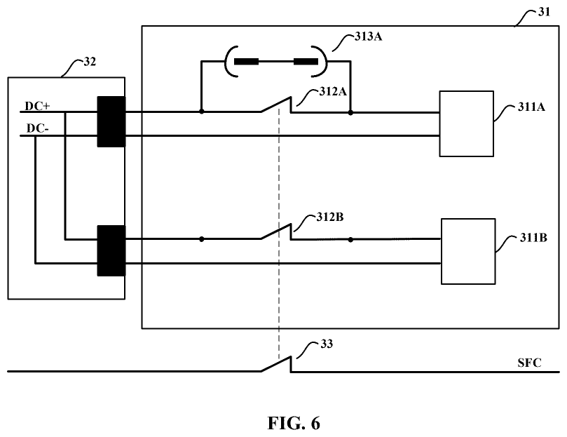

FIG. 6 shows a schematic diagram of the elevator braking system illustrated in FIG. 3 in a second test mode. In the second mode, the holding brakes 311A and 311B are connected to the drive power supply 32 via the normally closed contacts 312A and 312B respectively. Unlike the scenario as illustrated in FIG. 5, the connector 313A is connected to both ends of the normally closed contact 312A, while the connector 313B is not connected to both ends of the normally closed contact 312B. During the test, when the normally closed contacts 312A and 312B are transitioned from a closed state to a disconnected state by manual operation of the safety switch 33, the holding brake 311A does not provide braking force due to the bypass effect of the connector 313A. On the other hand, the electromagnet of the holding brake 311B is de-energized as the normally closed contact 312B enters a disconnected state, and thus it is possible to determine whether the functionality of the holding brake 311B is operating normally based on the motion state of the car after the normally closed contact 312B is transitioned from a closed state to a disconnected state.

Exemplarily, it is possible to determine whether the braking force is sufficient (e.g., whether the braking distance exceeds a threshold value) based on the distance travelled (braked) by the car before it stops moving, or determine whether the braking force is sufficient (e.g., whether the peak velocity exceeds a threshold value) based on the curve of velocity change over time before the car stops moving. It should be noted that the determination of whether the holding brake functionality is normal is typically performed by an elevator controller (e.g., the controller 220 in FIG. 2).

Compared with using a dedicated brake functionality test tool, setting a normally closed contact between a holding brake and a drive power supply, and controllably bypassing the normally closed contact by means of a connector makes it possible to complete the brake functionality test in a convenient and economical way.

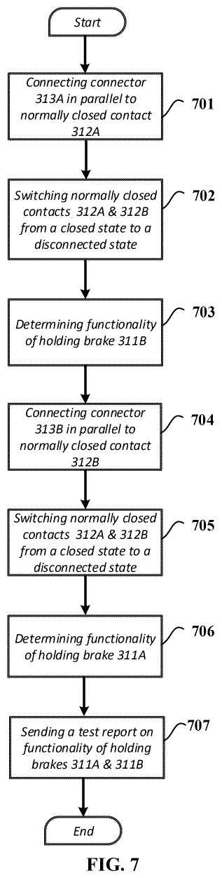

FIG. 7 shows a flow diagram of a method for testing functionality of an elevator braking system according to another embodiment of the present disclosure. Exemplarily, the elevator braking system illustrated in FIGS. 3-6 is described herein as an example.

The method illustrated in FIG. 7 comprises the following steps:

Step 701: The connector 313A is connected in parallel to both ends of the normally closed contact 312A, for example, as shown in FIG. 6.

Step 702: The normally closed contacts 312A and 312B are transitioned from a closed state to a disconnected state, for example, by controlling the safety switch 33. As noted above, the holding brake 311A does not work at this moment, and the braking force will be provided only by the holding brake 311B.

Step 703: The elevator controller or elevator safety device determines whether the functionality of the holding brake 311B is operating normally based on the motion state of a car after the normally closed contact 312A is transitioned from a closed state to a disconnected state.

Step 704: The connector 313A is removed and the connector 313B is connected in parallel to both ends of the normally closed contact 312B, for example, as shown in FIG. 5.

Step 705: The normally closed contacts 312A and 312B are transitioned from a closed state to a disconnected state, for example, by controlling the safety switch 33. As noted above, the holding brake 311B does not work at this moment, and the braking force will be provided only by the holding brake 311A.

Step 706: The elevator controller or elevator safety device determines whether the functionality of the holding brake 311A is operating normally based on the motion state of the car after the normally closed contact 312B is transitioned from a closed state to a disconnected state.

Step 707: The elevator controller or elevator safety device sends a test report on the functionality of the holding brakes 311A and 311B to an external device (e.g., the cloud or a mobile device of a maintenance personnel).

A person skilled in the art will appreciate that, various illustrative logic blocks, modules, circuits and algorithmic steps described herein may be implemented as electronic hardware, computer software or a combination of both.

To demonstrate interchangeability between hardware and software, various illustrative components, blocks, modules, circuits and steps have been described above in general terms based on their functionality. Such functionality is implemented in the form of hardware or software, depending on particular applications and design constraints imposed on the overall system. A person skilled in the art may implement the described functionality in varying ways for particular applications, but such implementation decisions should not be construed to result in a departure from the scope of the present disclosure.

While only some embodiments of the present disclosure are described, it should be understood by a person skilled in the art that the present disclosure can be implemented in various other forms without departing from its main purpose and scope. Therefore, the examples and embodiments provided are intended to be illustrative rather than restrictive, and the present disclosure may encompass various modifications and substitutions without departing from the spirit and scope of the present disclosure as defined in the appended claims.

The embodiments and examples are provided herein to best explain the embodiments of the technology and its particular application, so that a person skilled in the art can exploit and implement the present disclosure. However, a person skilled in the art will appreciate that the foregoing description and examples are provided for the purpose of illustration and exemplification only. The description provided is not intended to cover every aspect of the present disclosure or to limit the present disclosure to the precise form disclosed.

What is claimed is:

1. A method for testing functionality of an elevator braking system, wherein the elevator braking system comprises: a first holding brake and a second holding brake; a first contact connected between the first holding brake and a drive power supply, and a second contact connected between the second holding brake and the drive power supply; and a first connector controllably connected in parallel to both ends of the first contact, and a second connector controllably connected in parallel to both ends of the second contact, the method comprising:
connecting the first connector in parallel to both ends of the first contact;
transitioning the second contact from a closed state to a disconnected state;
determining whether the functionality of the second holding brake is operating normally based on a motion state of a car after the second contact is transitioned from a closed state to a disconnected state;
connecting the second connector in parallel to both ends of the second contact;
transitioning the first contact from a closed state to a disconnected state; and
determining whether the functionality of the first holding brake is operating normally based on the motion state of the car after the first contact is transitioned from a closed state to a disconnected state.

2. The method according to claim 1, wherein the first contact and the second contact are controlled by an emergency stop switch.

3. The method according to claim 1, wherein the first connector and the second connector take a form of plug/socket connectors.

4. The method according to claim 1, wherein the motion state comprises at least one of: a distance travelled by the car before it stops moving, and a curve of velocity change over time of the car before it stops moving.

5. An elevator braking system, comprising:
a first holding brake and a second holding brake;
a first contact connected between the first holding brake and a drive power supply, and a second contact connected between the second holding brake and the drive power supply; and
a first connector controllably connected in parallel to both ends of the first contact, and a second connector controllably connected in parallel to both ends of the second contact,
wherein the elevator braking system comprises a first test mode and a second test mode; in the first mode, the first connector is connected in parallel to both ends of the first contact, and the second contact is transitioned from a closed state to a disconnected state to determine whether the functionality of the second holding brake is operating normally based on a motion state of a car after the second contact is transitioned from a closed state to a disconnected state; in the second test mode, the second connector is connected in parallel to both ends of the second contact, and the first contact is transitioned from a closed state to a disconnected state to determine whether the functionality of the first holding brake is operating normally based on the motion state of the car after the first contact is transitioned from a closed state to a disconnected state.

6. The elevator braking system according to claim 5, further comprising an emergency stop switch interlinked with the first contact and the second contact to control the first contact and the second contact.

7. The elevator braking system according to claim 6, wherein the emergency stop switch is a manual switch.

8. The elevator braking system according to claim 5, wherein the first connector and the second connector take the form of plug/socket connectors.

9. The elevator braking system according to claim 8, wherein the sockets of the plug/socket connectors are fixedly disposed at both ends of the first contact and the second contact, and the sockets are suitable for electrical connection via a cable with plugs provided at the ends.

10. The elevator braking system according to claim 9, wherein the first connector and the second connector share the same cable.
